(19) United States
(12) Patent Application Publication
(10) Pub. No.: US 2024/0272019 A1
(43) Pub. Date: Aug. 15, 2024

(54) LIQUID MAGNET SENSOR

(71) Applicant: FLORIDA ATLANTIC UNIVERSITY BOARD OF TRUSTEES, Boca Raton, FL (US)

(72) Inventor: Erik D. ENGEBERG, Boca Raton, FL (US)

(21) Appl. No.: 18/569,912

(22) PCT Filed: Jun. 15, 2022
(86) PCT No.: PCT/US2022/033513

§ 371 Date: Dec. 13, 2023

Related U.S. Application Data
(60) Provisional application No. 63/211,079, filed on Jun. 16, 2021.

(51) Int. Cl. G01L 1/12

(52) U.S. Cl. CPC G01L 1/122

(57) ABSTRACT

A novel sensor, intended for use in applications for robots, prosthetics, biomedical devices, or the internet of things, using a ferrous magnetic fluid is presented here. The sensor includes a deformable member containing the magnetic fluid therein and an array of Hall effect sensors to measure the changing magnetic field in the fluid as the deformable member is deformed. The sensor was found to be sensitive to varying applied pressure and is capable of resolving both the location and amplitude of externally applied forces. The range of applications for this novel pressure sensor are broad, ranging from robotics to biomedical devices and the Internet of things. The novel sensor can also be used as an orientation sensor or an accelerometer, torque detector and linear shear forces detector.

### CROSS-REFERENCE TO RELATED APPLICATIONS

This PCT application claims the benefit under 35 U.S.C. § 119(e) of Application Ser. No. 63/211,079 filed on Jun. 16, 2021 entitled LIQUID MAGNET SENSOR and whose entire disclosure is incorporated by reference herein.

### BACKGROUND OF THE INVENTION

The present invention is related generally to a sensor and more particularly to a liquid magnet sensor that can distinctly detect amplitudes and locations of applied forces with high resolution, as well as detecting orientation and acceleration.

In robotic hand or gripper applications it is of interest to make the devices better able to sense the environment to be able to better serve the end user's application, whether that may be in industry, a prosthesis, or surgery. Specifically, enhanced tactile sense is essential to creating a more effective robotic hand. Robotic hands must be able to receive feedback to know when it is gripping something and how hard to effectively meet a user's needs. Developments in soft sensors taking advantage of elastic materials have attempted to meet these needs are discussed in below in the references [1][5][6][7][8][9] listed at the end of this Specification.

Some touch sensing applications use an array of sensors embedded in a soft elastic material that generate a signal when the soft material is deformed. [1] created a large-area flexible tactile sensor measuring capacitance changes as conductive strips embedded in an elastic material were deformed. [5] created a sensor using magnetic wires embedded in a flexible silicone material to mimic cilia fibers. [6] embedded a permanent magnet in a rubber gel and detected the magnet's displacement using magneto resistance elements and inductors. [7] made a series of cylindrical permanent magnets embedded in a soft material atop four inductors for each magnet. [9] used an array of small permanent magnets in a soft material whose deformations were sensed by Hall effect sensors. [9] tested multiple resolutions and demonstrated the sensor on a robotic hand.

While some tactile sensing applications use magnets to function, in the literature there are very few applications taking advantage of ferromagnetic fluids, or ferrofluids. [3] and [4] used a ferrofluid in a haptic display for a computer mouse application used a ferrofluid to create a tactile display, providing haptic feedback to a user. U.S. Pat. No. 5,396,802 (Moss) discloses an industrial device that measures differential pressure in an environment using “a ferrofluid contained in two interconnecting chambers, enclosed by two non-magnetic spring diaphragms” where the Hall effect sensors measure the variation of volume in each interconnecting chamber [2].

Thus, there remains a need for a pressure sensor that utilizes a ferrous magnetic fluid (also referred to as ferrofluid or ferromagnetic fluid) for distinctly detecting amplitudes and locations of applied forces with high resolution for possible use in, e.g., robotic hands, biomedical devices and the Internet of things. The present invention solves this problem.

All references cited herein are incorporated herein by reference in their entireties.

### BRIEF SUMMARY OF THE INVENTION

A pressure sensor is disclosed. The pressure sensor comprises: a first element comprising a deformable material having a ferrous magnetic fluid (e.g., a ferrofluid, a ferromagnetic fluid, etc.) therein, wherein the ferrous magnetic fluid exhibits a magnetic field; a second element positioned adjacent the first element and comprising an array of Hall effect sensors; and wherein the Hall effect sensors detect changes in the magnetic field when pressure is applied against the first element, and wherein the Hall effect sensors generate output signals corresponding to a location and amplitude of at least one applied pressure on the first element.

A method for distinctly detecting the amplitude and location of an applied pressure with high resolution is disclosed. The method comprises: providing a first element comprising a deformable material having a ferrous magnetic fluid (e.g., a ferrofluid, a ferromagnetic fluid, etc.) therein, wherein the ferrous magnetic fluid exhibits a magnetic field; positioning a second element adjacent the first element and wherein the second element comprises an array of Hall effect sensors; applying a pressure against the first element causing the Hall effect sensors to detect changes in the magnetic field; and generating output signals, by the Hall effect sensors, corresponding to a location and amplitude of at least one applied pressure on the first element.

A situational sensor for detecting orientation or acceleration is disclosed. The sensor comprises: a first element comprising a ferrous magnetic fluid (e.g., a ferrofluid, a ferromagnetic fluid, etc.) therein, wherein the ferrous magnetic fluid exhibits a magnetic field; a second element positioned adjacent the first element and comprises an array of Hall effect sensors; and wherein the Hall effect sensors detect changes in the magnetic field as the ferrous magnetic fluid redistributes within the first element, corresponding to situational sensor orientation or acceleration, and generating output signals corresponding to the situational sensor orientation or situational sensor acceleration.

A method for detecting orientation is disclosed. The method comprises: providing a first element comprising having a ferrous magnetic fluid (e.g., a ferrofluid, a ferromagnetic fluid, etc.) therein wherein the ferrous magnetic fluid exhibits a magnetic field; positioning a second element adjacent the first element and wherein the second element comprises an array of Hall effect sensors, wherein the first and second elements form a situational sensor; orienting the situational sensor to cause changes in the magnetic field of the ferrous magnetic fluid; and generating output signals, by the Hall effect sensors, corresponding to the changes in the magnetic field indicative of the orientation of the situational sensor.

A method for detecting acceleration is disclosed. The method comprises: providing a first element comprising having a ferrous magnetic fluid (e.g., a ferrofluid, a ferromagnetic fluid, etc.) therein wherein the ferrous magnetic fluid exhibits a magnetic field; positioning a second element adjacent the first element and wherein the second element comprises an array of Hall effect sensors, wherein first and second elements form a situational sensor; accelerating the situational sensor to cause changes in the magnetic field of the ferrous magnetic fluid; and generating output signals, by the Hall effect sensors, corresponding to the changes in the magnetic field indicative of the acceleration of the situational sensor.

### BRIEF DESCRIPTION OF SEVERAL VIEWS OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is an enlarged cross-sectional view of the novel sensor apparatus of the present invention;

FIG. 1A is an enlarged cross-sectional view of another embodiment of the novel sensor apparatus similar to FIG. 1 but where the deformable material comprises the ferrous magnetic fluid embedded therein;

FIG. 2 depicts a printed circuit board (PCB) for the Hall effect sensor array as compared to the size of a dime;

FIG. 3 is a functional diagram of the Hall effect sensor array labelling each Hall effect sensor with a number from 1-9 on the PCB;

FIG. 4 is an isometric view of a two-pronged probe;

FIG. 5 is an isometric view of a test fixture with the sensor assembly thereon;

FIG. 6 is a signal vs. time plot of Trial #2 showing locations 7, 1, 9, 3 and 5;

FIG. 7 is a signal vs. time plot of Trial #2 showing only signals 7, 8 and 9;

FIG. 8 is s signal vs. time plot of Trial #9, involving the pressing with the one and two-prong probes;

FIG. 9 is a signal vs. time plot of Trial #9 with only signals 7, 8 and 9 shown therein;

FIG. 10 is a signal vs. time plot of Trial #10 with the two-prong probe being using in two different orientation perpendicular to each other;

FIG. 11 is a signal vs. time plot of Trial #10 with only signals 7, 8 and 9 shown therein;

FIG. 12 is a signal vs. time plot of Trial #13 showing increasing force applied over five seconds;

FIG. 13 is a signal vs. time plot of Trial #13 with only signals 7, 8 and 9 shown therein;

FIG. 14 is a signal vs. time plot of Trial #14 depicting light presses followed by hard presses;

FIG. 15 is a signal vs. time plot of Trial #14 with only signals 7, 8 and 9 shown therein;

FIG. 16 is partial view of an artificial finger of a robotically-controlled hand, having the pressure sensor of the present invention installed on the bottom side of the artificial finger;

FIG. 16A is a top view of the robotically-controlled hand of FIG. 16 having corresponding fingers with the pressure sensor of the present invention installed on the underside of each finger;

FIG. 17 is a block diagram of the Simulink model used for processing all of the trial data;

FIG. 18 is an exemplary set of the software code used with the Simulink model in processing the trial data;

FIG. 19 is a Table #2 which includes a summary of all 14 experimental trials conducted;

FIG. 20 is a signal vs. time plot for Trial #1;

FIG. 21 is a signal vs. time plot for Trial #2;

FIG. 22 is a signal vs. time plot for Trial #3;

FIG. 23 is a signal vs. time plot for Trial #4;

FIG. 24 is a signal vs. time plot for Trial #5;

FIG. 25 is a signal vs. time plot for Trial #6;

FIG. 26 is a signal vs. time plot for Trial #7;

FIG. 27 is a signal vs. time plot for Trial #8;

FIG. 28 is a signal vs. time plot for Trial #9;

FIG. 29 is a signal vs. time plot for Trial #10;

FIG. 30 is a signal vs. time plot for Trial #11;

FIG. 31 is a signal vs. time plot for Trial #12;

FIG. 32 is a signal vs. time plot for Trial #13;

FIG. 33 is a signal vs. time plot for Trial #14;

FIG. 34 is a signal vs. time plot for using the present invention to detect rotation;

FIG. 35 is a signal vs. time plot for using the present invention to detect acceleration;

FIGS. 36A-36B together depict a configuration for applying various torques to the sensor of the present application, namely, a downward force (FIG. 36A) and then a twisting force (FIG. 36B) to the sensor;

FIG. 37 provides sensor outputs (“LMS”) for the configuration of FIGS. 36A-36B with a 5° clockwise rotation;

FIG. 38 provides sensor outputs (“LMS”) for the configuration of FIGS. 36A-36B with a 10° clockwise rotation; and

FIG. 39 provides sensor outputs (“LMS”) for the configuration of FIGS. 36A-36B with a 15° clockwise rotation.

### DETAILED DESCRIPTION OF THE PREFERRED EMBODIMENTS

Referring now to the figures, wherein like reference numerals represent like parts throughout the several views, exemplary embodiments of the present disclosure will be described in detail. Throughout this description, various components may be identified having specific values, these values are provided as exemplary embodiments and should not be limiting of various concepts of the present invention as many comparable sizes and/or values may be implemented.

Presented here is a novel pressure sensor that takes advantage of a ferrous magnetic fluid (FMF) which also can be referred to as “ferrofluid” or “ferromagnetic fluid”. The sensor comprises a soft or deformable material (e.g., a flexible silicone member) comprising an FMF and whose displacements would be sensed by an array of Hall effect sensors. As such, another term for the sensor is a “liquid magnet sensor” or “LMS”. The key performance indicators for the pressure sensor are whether it can be determined where on the deformable material a displacement occurs, how much pressure was applied to the deformable material, and whether the sensor can detect multiple displacements on the deformable material at different locations. The present application covers the design of the sensor, followed by an overview of the experiments and a presentation of the results.

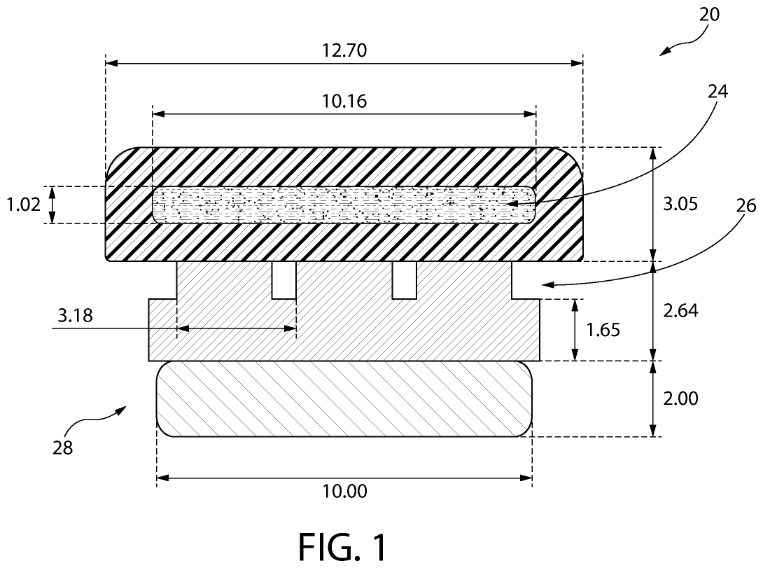

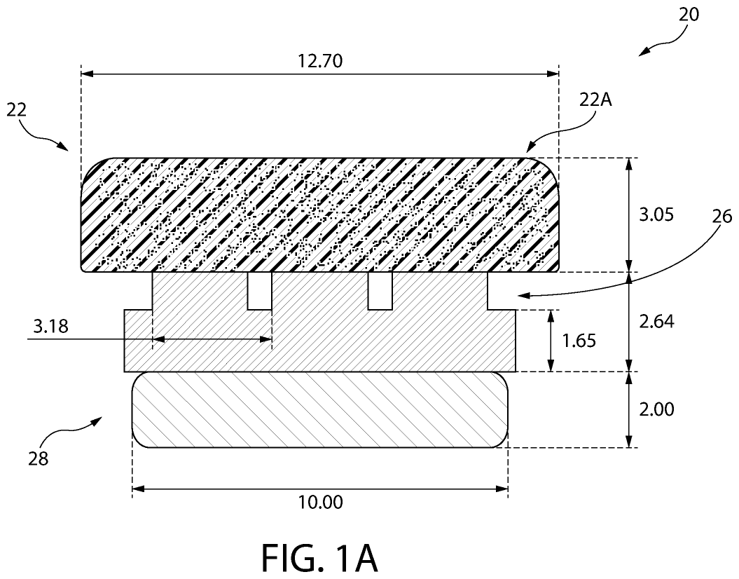

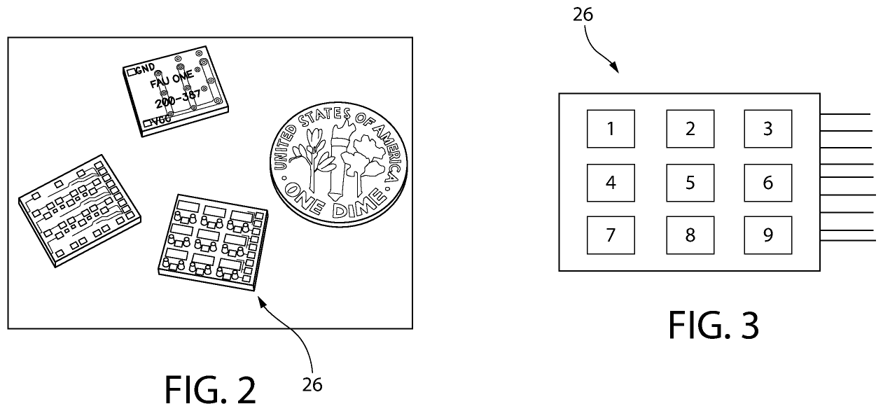

It should be understood that any dimensions presented herein (e.g., as shown in FIGS. 1 and 1A) are simply provided by way of example, and not limitation, to give a sense of the relative size of the novel sensor 20.

As shown in FIG. 1, the apparatus 20 is a pressure sensor having the deformable material 22 comprise a flexible member having an internal chamber (e.g., 12.7 mm×12.7 mm×3.1 mm) and composed of an elastic silicone, known as Ecoflex™ 00-50, which is filled with a FMF 24, such as that disclosed in U.S. Pat. No. 5,396,802 (Moss), whereby the magnetic saturation of the FMF 24 is, by way of example only, 600 Gauss, and whose entire disclosure is incorporated by reference herein.

An array 26 (e.g., 12 mm×10 mm×2.6 mm) of Hall effect sensors (e.g., DRV5055A1QDBZR Hall effect sensor by Texas Instruments) in a PCB that sense magnetic fields is positioned adjacent the deformable material 22. By way of example only the array 26 shown in FIG. 1 is placed underneath the deformable material 22 but it should be understood that the array 26 could be placed above the deformable material 22, or to the side of the deformable material 22, etc., as long as the array 26 is within a sensing range (e.g., up to 1 cm) of the array 26. The reference number “26” refers to the array of Hall effect sensors, as well as these sensors on the PCB.

Adjacent the Hall effect sensor PCB 26 is a magnet 28 (e.g., 10 mm×10 mm×2 mm), which may comprise a permanent magnet or an electromagnet and, as such, the term “magnet 28” includes either. Again, by way of example only, the magnet 28 is placed underneath the array 26 but it should be understood that the magnet 28 could be placed anywhere adjacent the sensor 20, as mentioned above with regard to the array 26. As such, by way of example only, the pressure sensor 20 comprises the deformable material 22 on top, the Hall effect sensor array circuit board 26 in the middle, and the magnet 28 on the bottom.

When assembled to a test fixture 27 (FIG. 5), in a receptacle 27A, an additional Ecoflex™ 00-50 is molded over the pressure sensor 20, and the array 26 is enclosed in a protective layer. The additional Ecoflex™ layer ensures that there is no relative movement between the deformable material 22 and the Hall sensor array PCB 26 during the trials. The test fixture 27 was secured to a load cell (not shown) using through-holes 27B for fastener passage.

It should be understood that the pressure sensor 20, in its broadest sense, comprises the deformable material 22 and the array 26. The third component, namely, magnet 28, enhances the magnetization of the ferrous magnetic fluid 24 but it is not required in the pressure sensor 20.

Moreover, FIG. 1A provides an alternative design to the deformable material 22, e.g., flexible silicone member having an internal chamber. In particular, as shown therein, the deformable material 22A does not include a distinct chamber having the FMF 24 therein; rather, the deformable material 22A comprises the FMF 24 embedded and cured therein. This mixture of the FMF 24 within the deformable material 22A may be a homogeneous or a non-homogeneous mixture. For example, the FMF 24 is mixed with a soft, stretchable elastomer whereby deformation of the deformable material 22A, and the subsequent changes in the magnetic field are detected by the Hall sensor array circuit board 26. It should be understood that the form factor shown in FIG. 1A is by way of example only and that the mixture could be molded into any desired shape, such as a hollow member, similar to a hemisphere.

It should also be understood that all of the following discussion applies to either of the embodiments of FIGS. 1-1A. As such, the term “deformable material 22” encompasses both of these sensor 20 configurations.

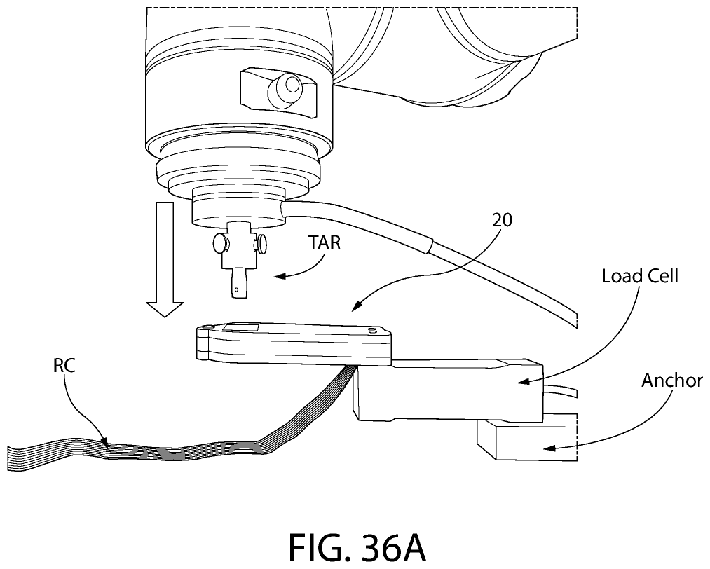

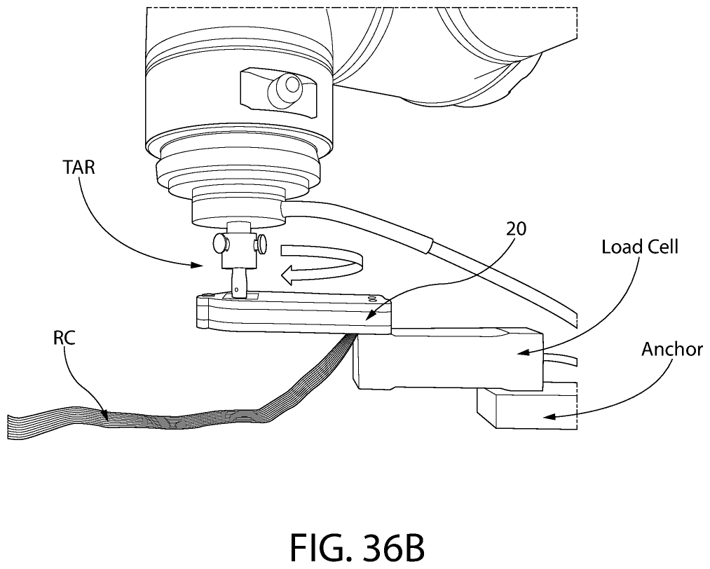

Sensor array 26 excitation and output signals from the array 26 is provided via electrical conductors (e.g., a ribbon cable RC; see for example FIGS. 36A-36B). The conductors are coupled at one end to the array 26 and at their other ends to a power supply (not shown) or to an output display/plotter (also not shown), accordingly.

### Methodology

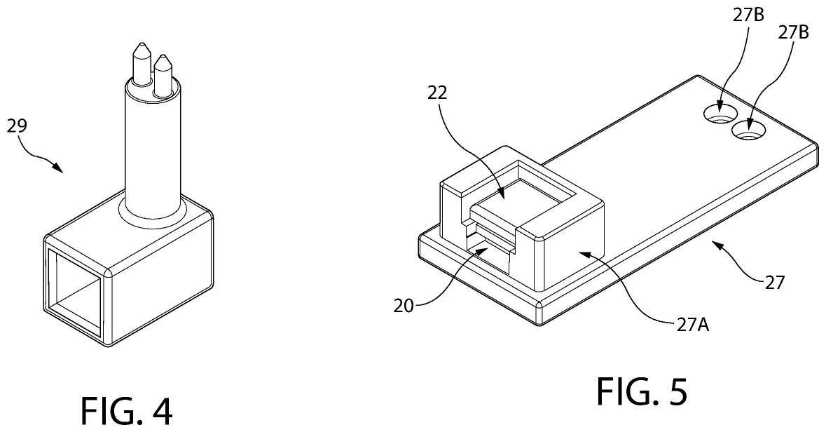

Several experimental trials were done to test the capabilities of the sensor 20. Each trial involved using a probe to apply some pressure to the deformable material 22 at some location on the surface of the deformable material 22. FIG. 3 depicts the Hall effect sensors using numbers on the array 26/PCB. The trials used involved two types of probes, one a single-pronged probe (not shown) with an approximate diameter of 2 mm, and a two-pronged probe 29 (FIG. 4), each 1 mm in diameter, with center points approximately 6.4 mm away from each other. As mentioned previously, a test fixture 27, FIG. 5, designed to attach to a load cell (not shown) was made to hold the sensor assembly 20 in place during the experiment. During the trials, both probes were hand-held when engaging the prong/prongs against the deformable material 22, although these could have as easily been conducted using an autonomous robotic arm.

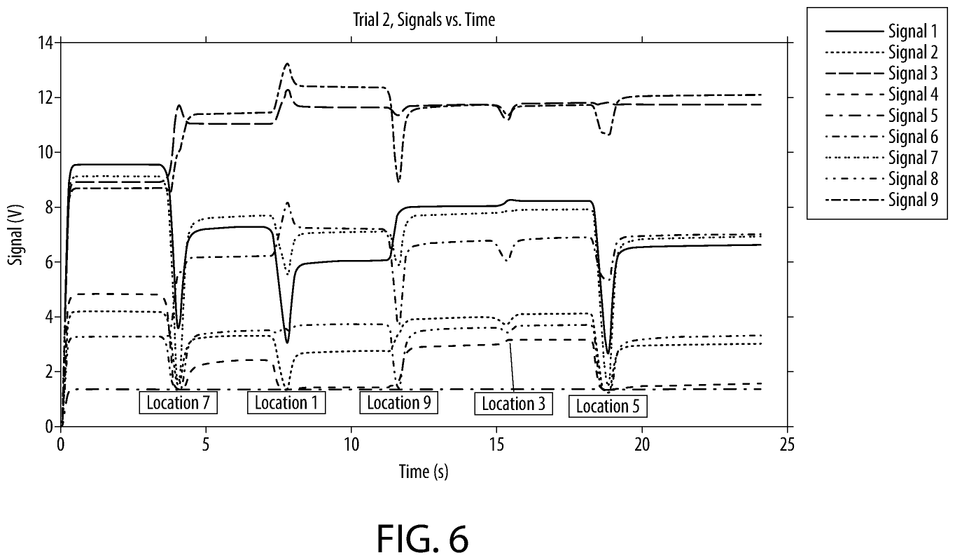

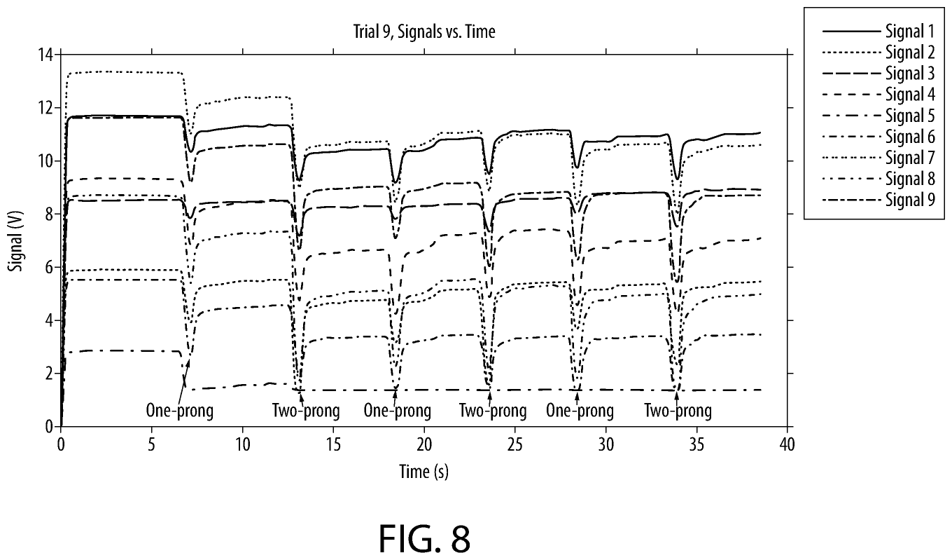

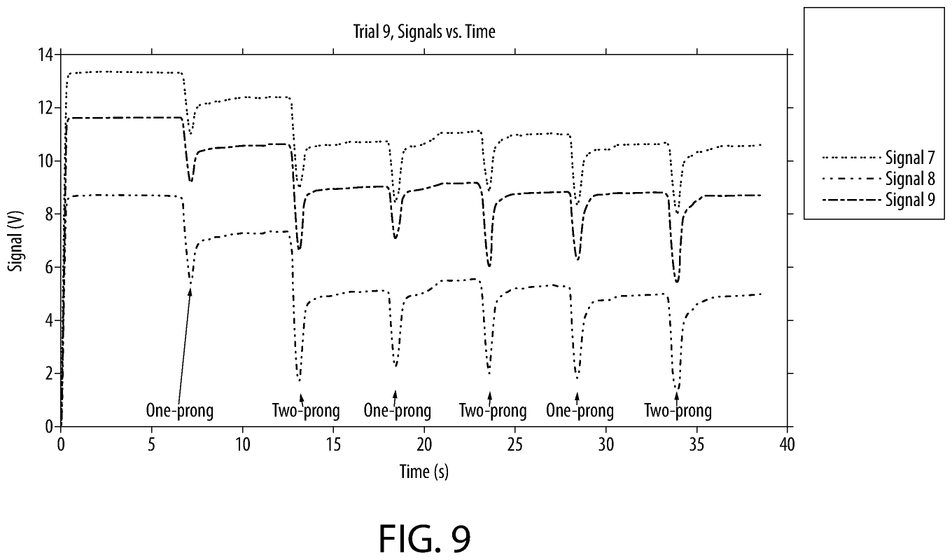

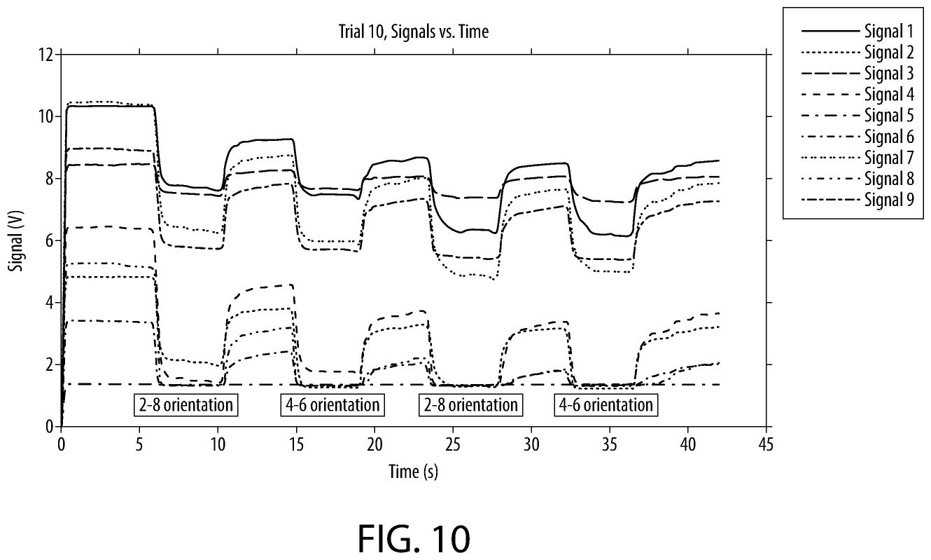

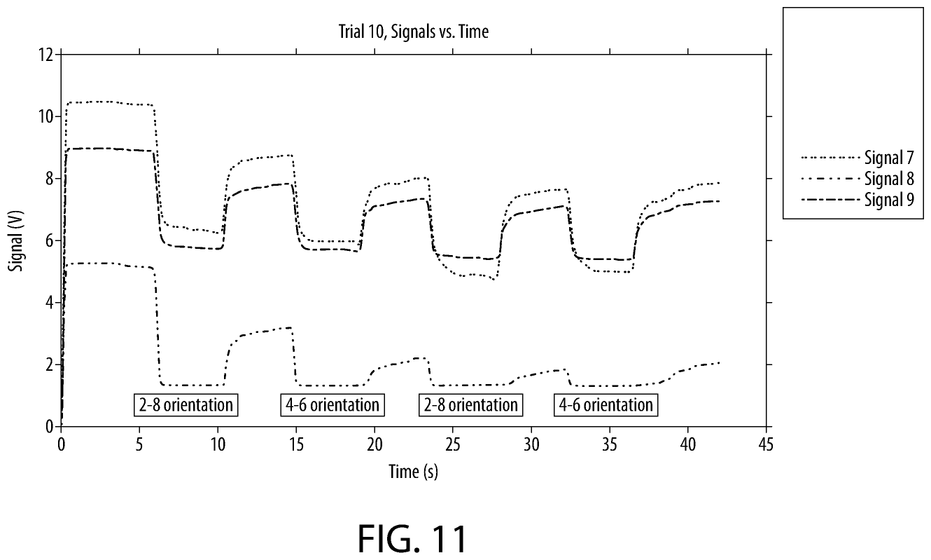

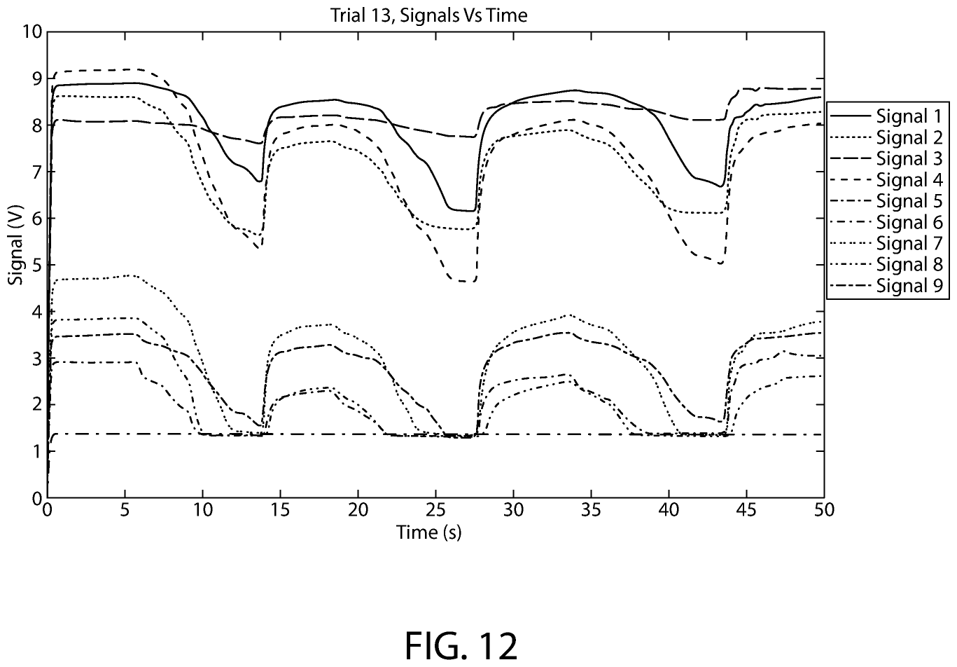

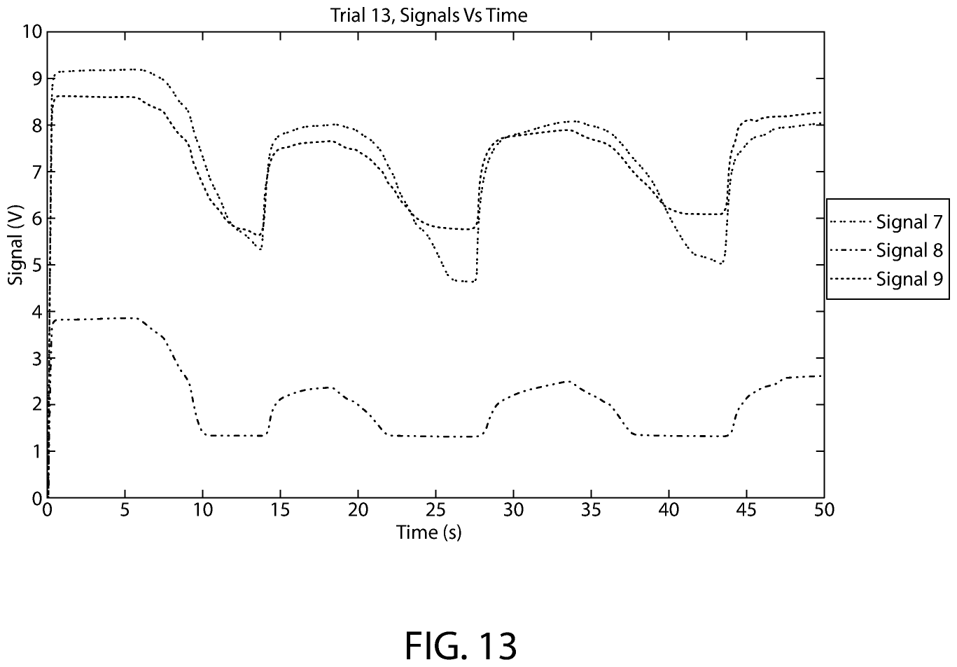

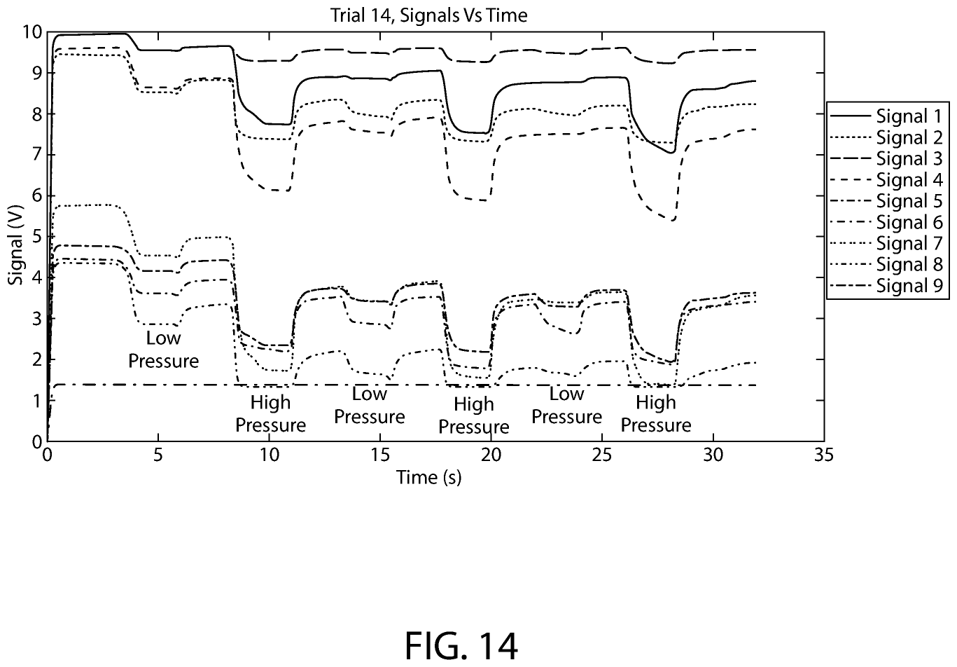

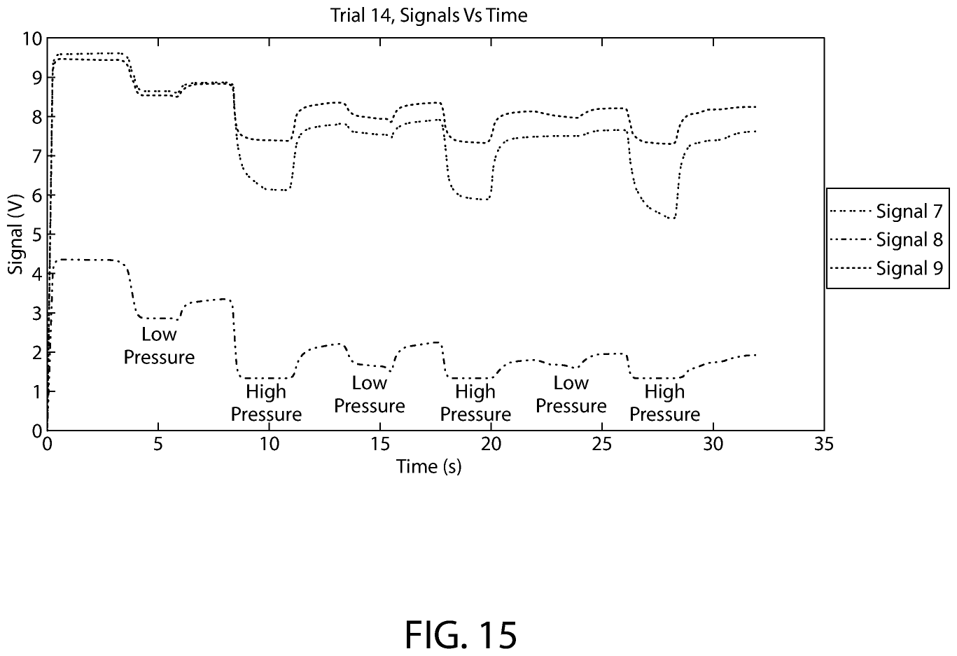

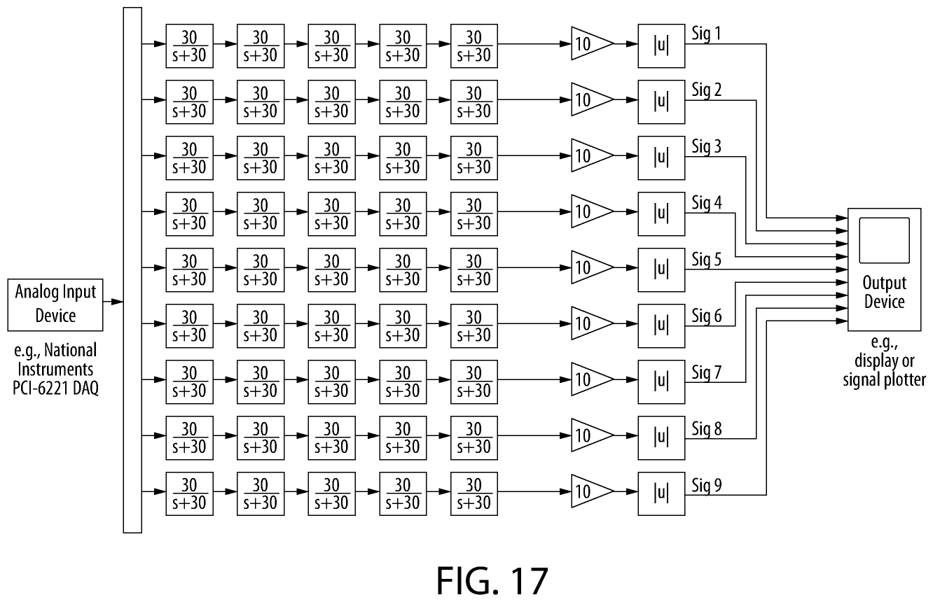

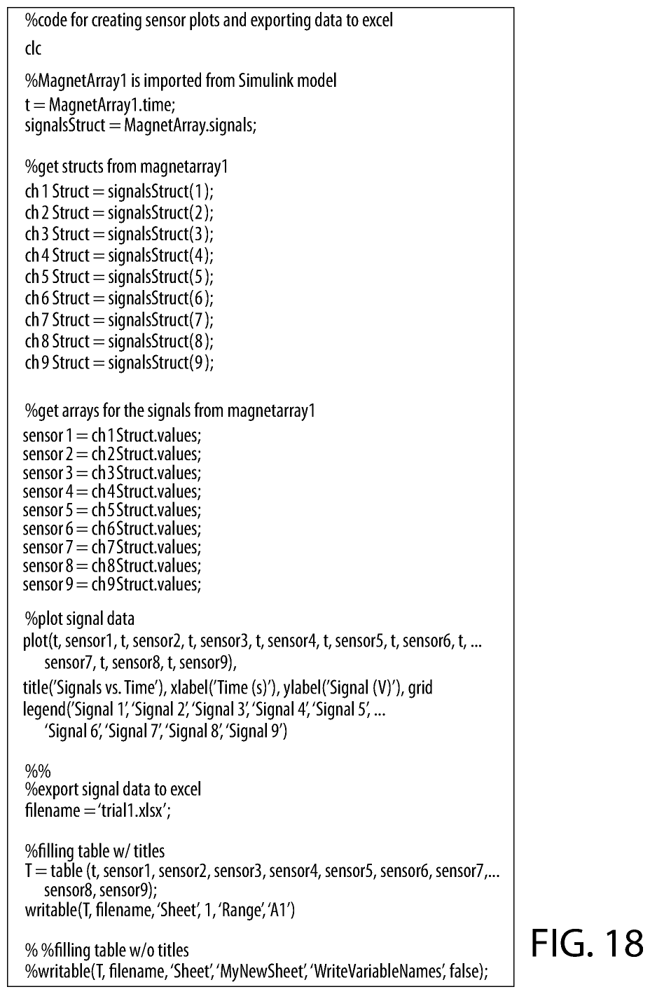

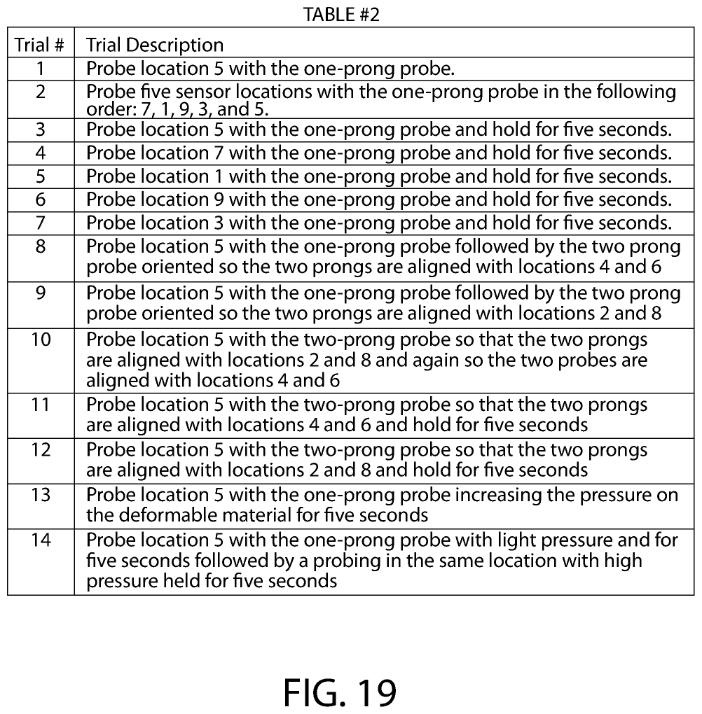

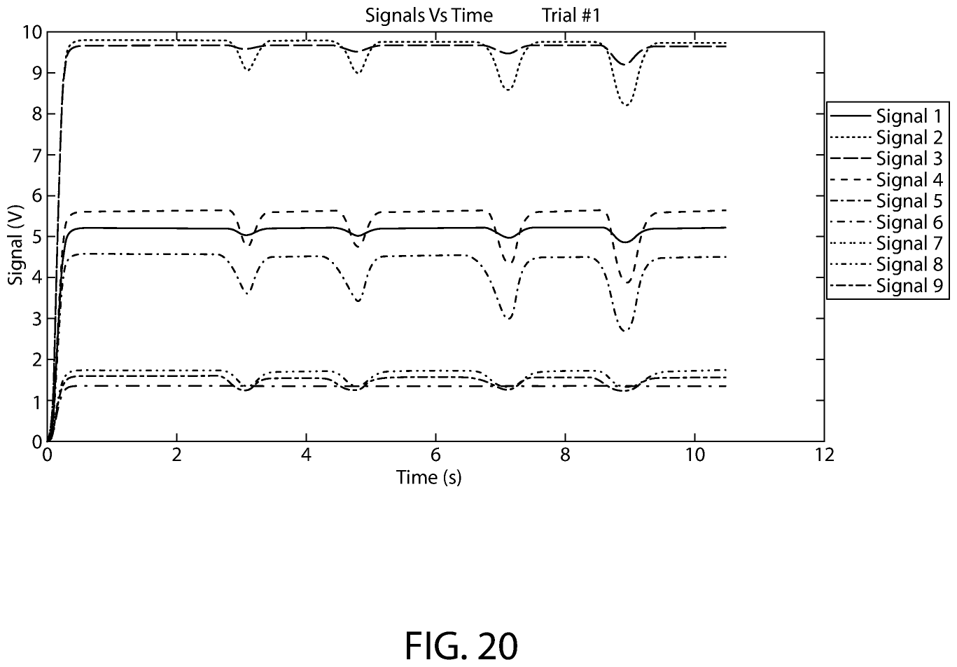

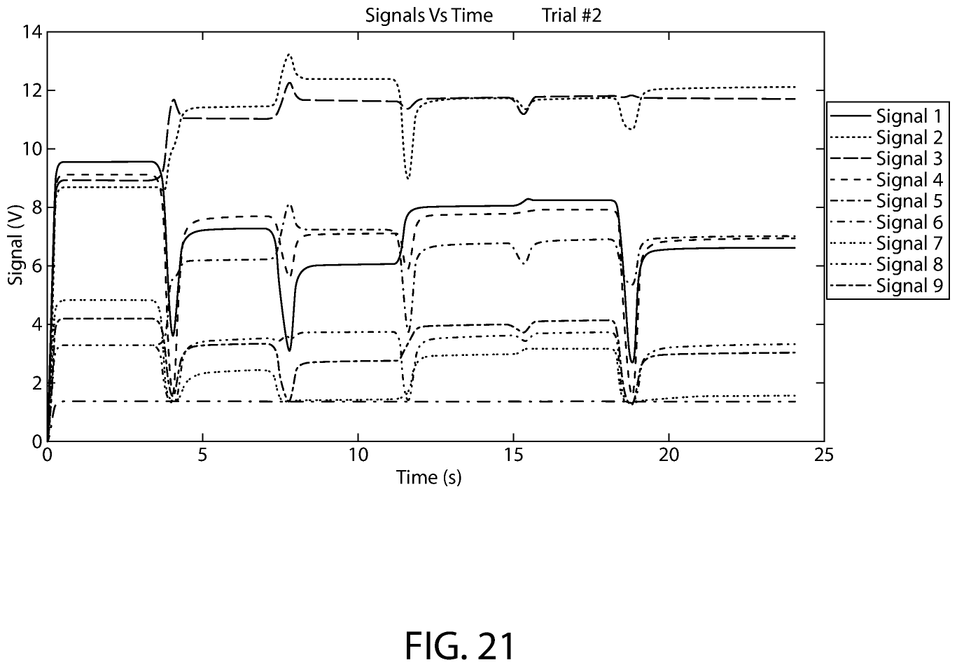

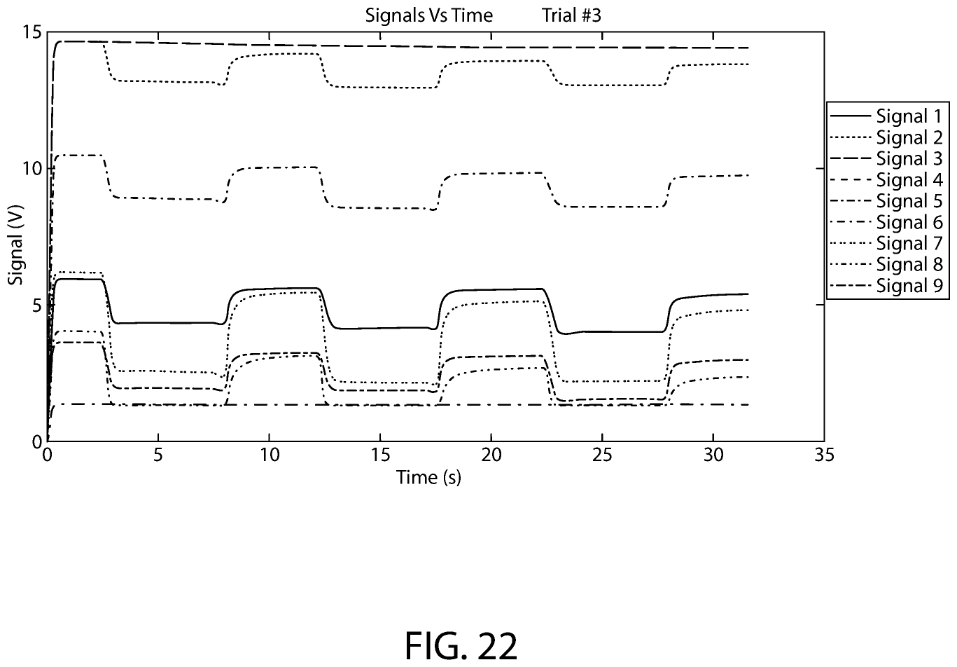

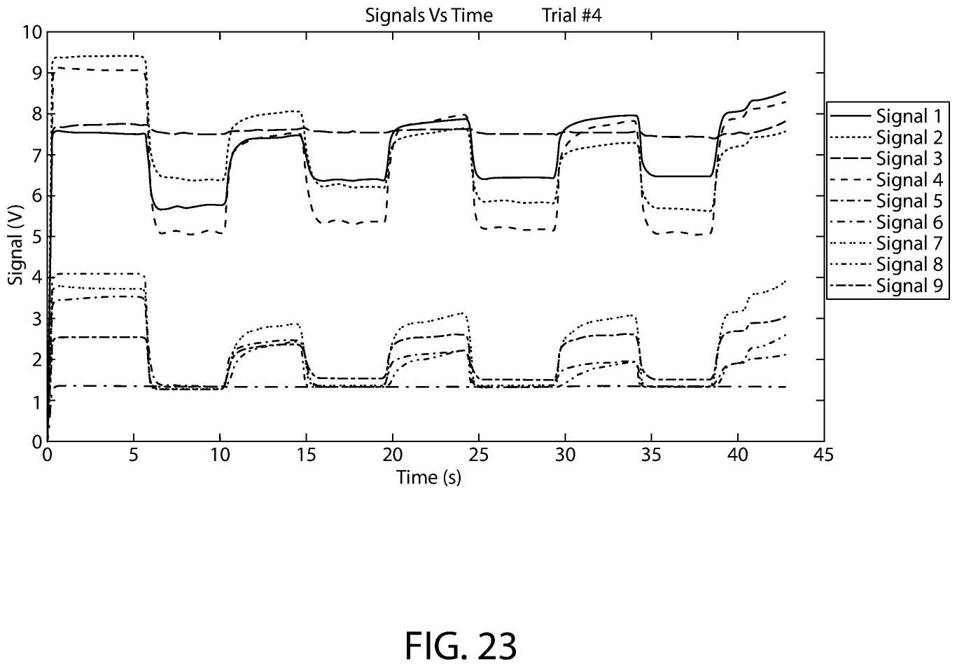

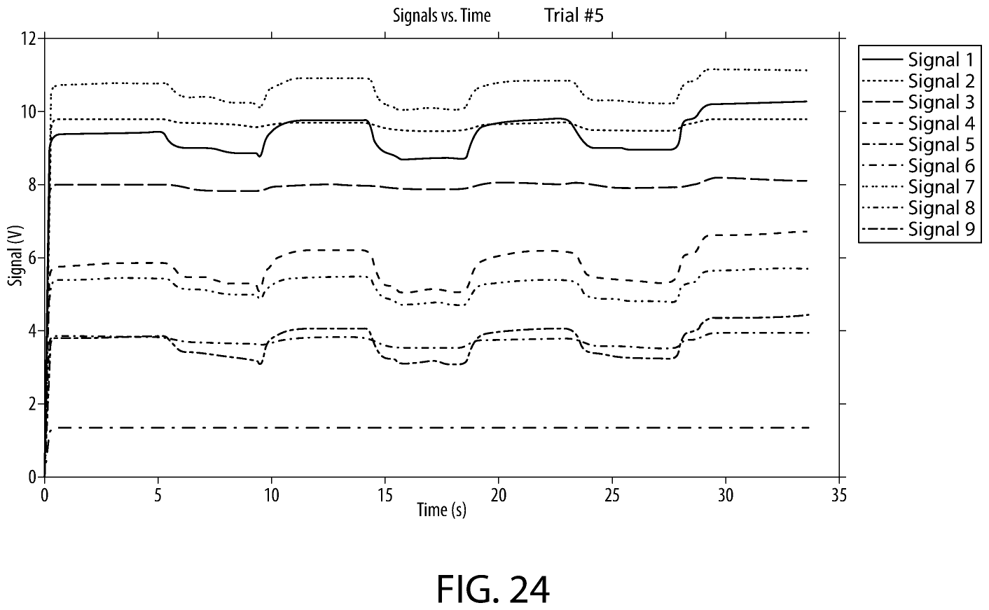

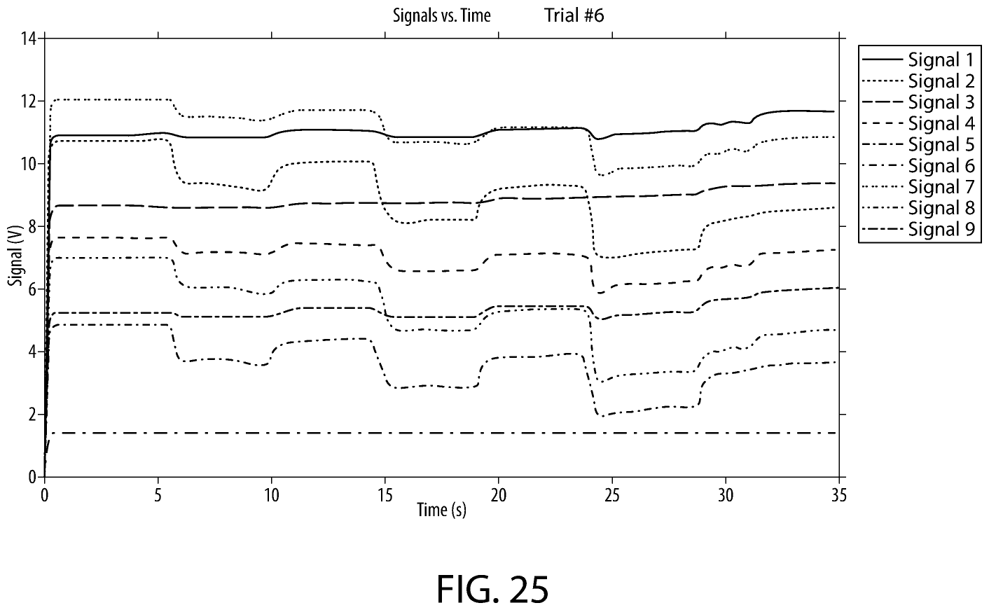

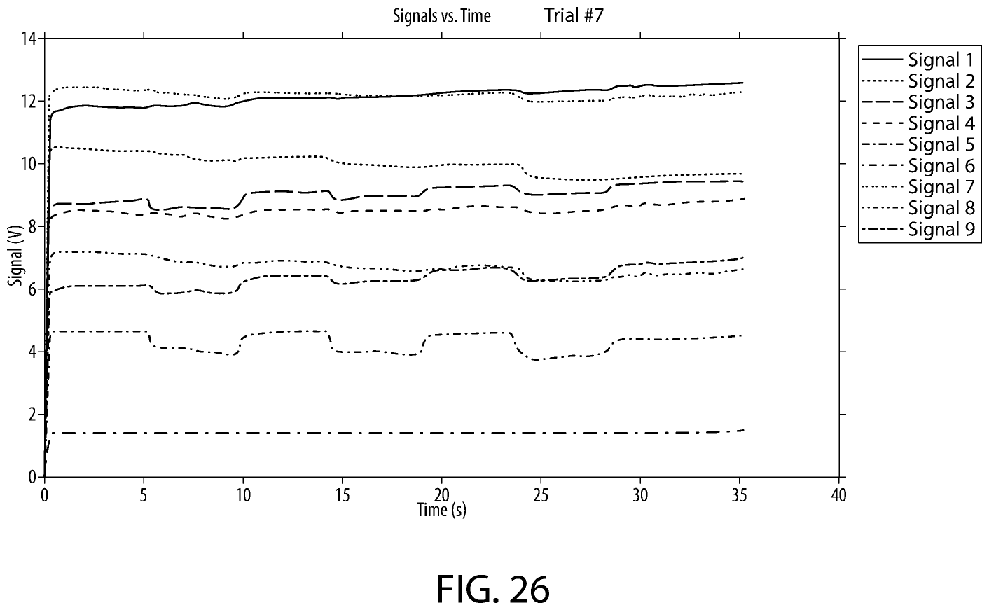

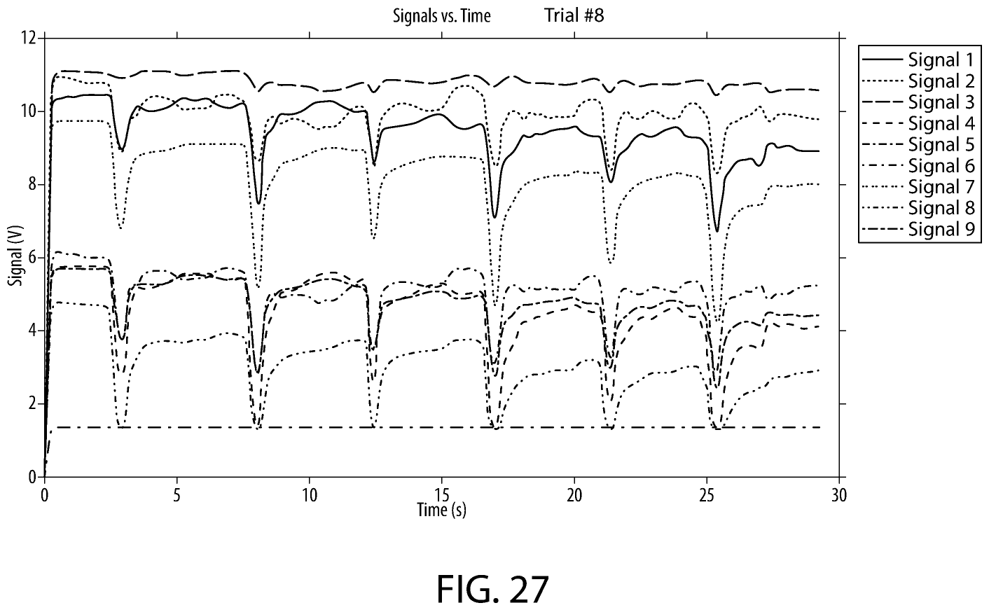

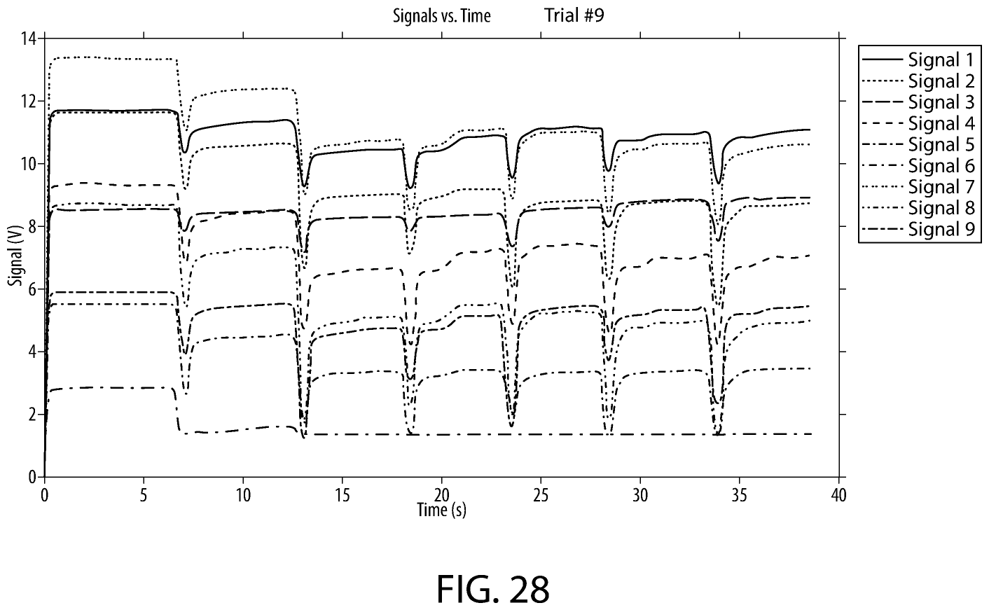

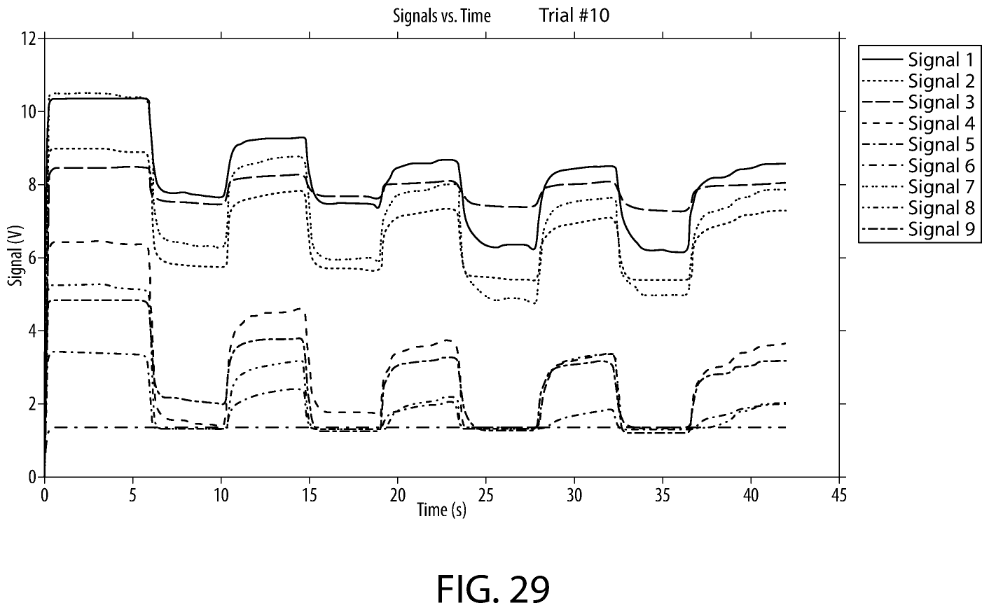

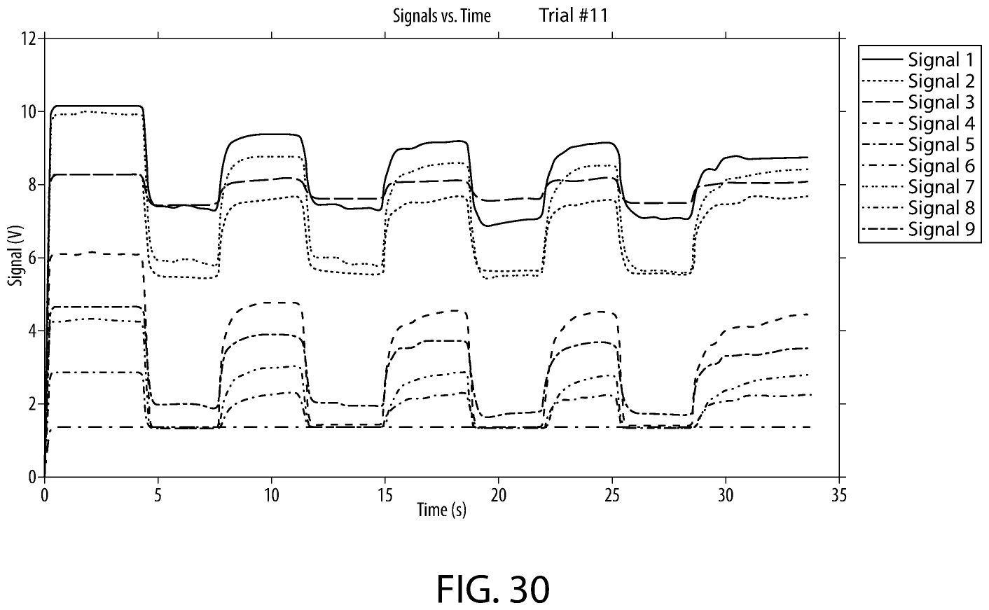

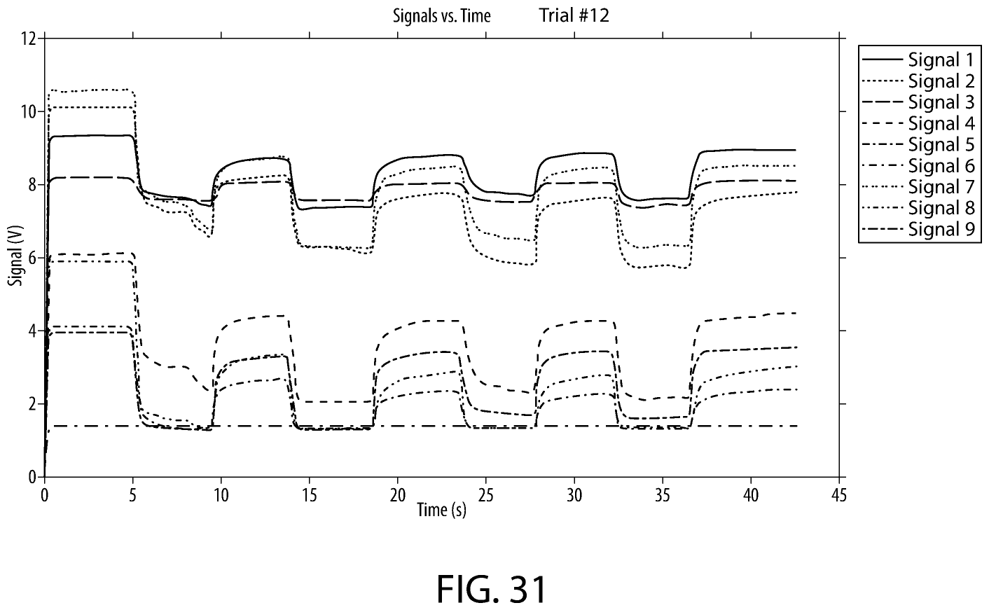

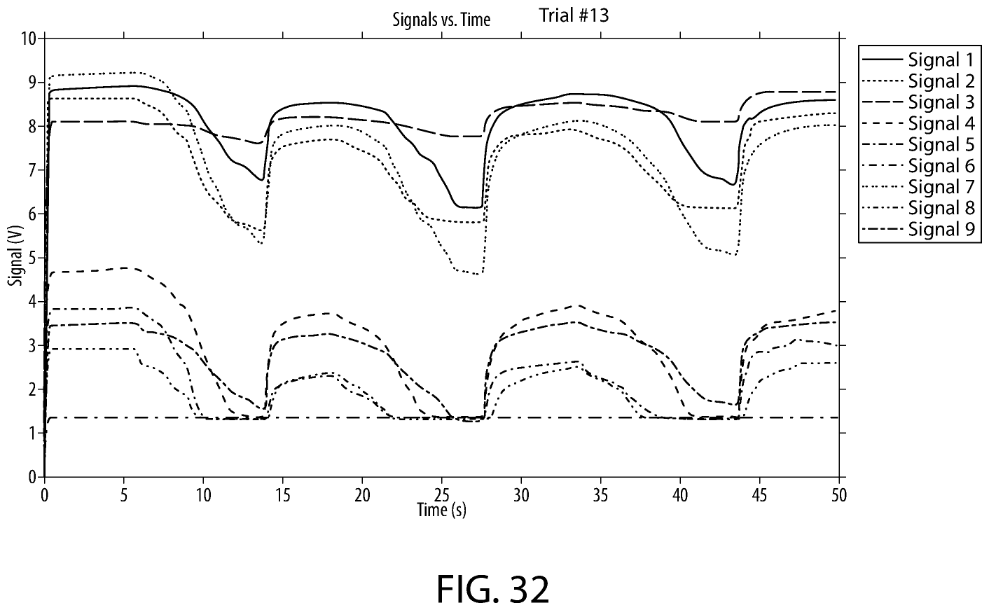

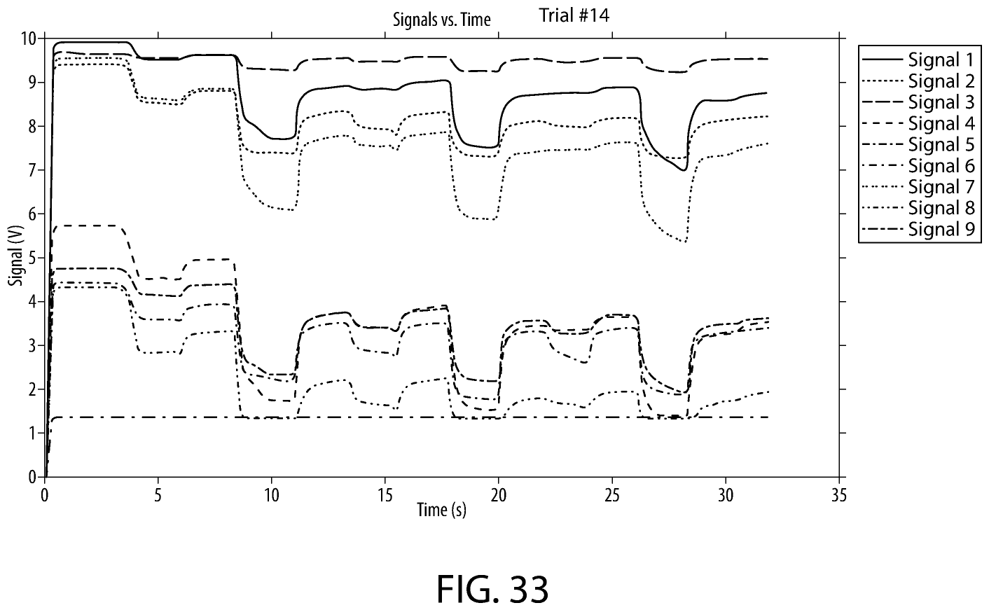

FIG. 19 is a table summarizing all the trials conducted; FIGS. 6-15 and 20-33 comprise all of the associated signal vs. time plots for the pressure sensing experiments. Table 1 below summarizes each relevant trial for pressure sensing discussed from hereon. All trials were processed in Simulink and MATLAB. The relevant model and code are depicted in FIGS. 17 and 18, respectively. Trial 2 addresses whether it can be determined where on the deformable material 22 a pressure was applied. Trials 9 and 10 address whether it can be determined if multiple points on the deformable material 22 are being pressed at once. Trial 13 and 14 address whether the sensor 20 can detect varying applied pressure.

TABLE 1
Experimental Trials

| Trial # | Trial Description |
|---|---|
| 2 | Probe five sensor locations with the one-prong probe in the following |
| | order: 7, 1, 9, 3, and 5. |
| 9 | Probe location 5 with the single-prong probe followed by two-prong |
| | probe oriented so the two prongs are aligned with locations 2 and 8. |
| 10 | Probe location 5 with the double-prong probe so the two prongs are |
| | aligned with locations 2 and 8 and again so the two probes are aligned |
| | with locations 4 and 6. |
| 13 | Probe location 5 with the single-prong probe increasing the pressure on |
| | the deformable material 22 for five seconds. |
| 14 | Probe location 5 with the single-prong probe with light pressure and hold |
| | for five seconds followed by a probing in the same location with high |
| | pressure held for five seconds. |

### Results

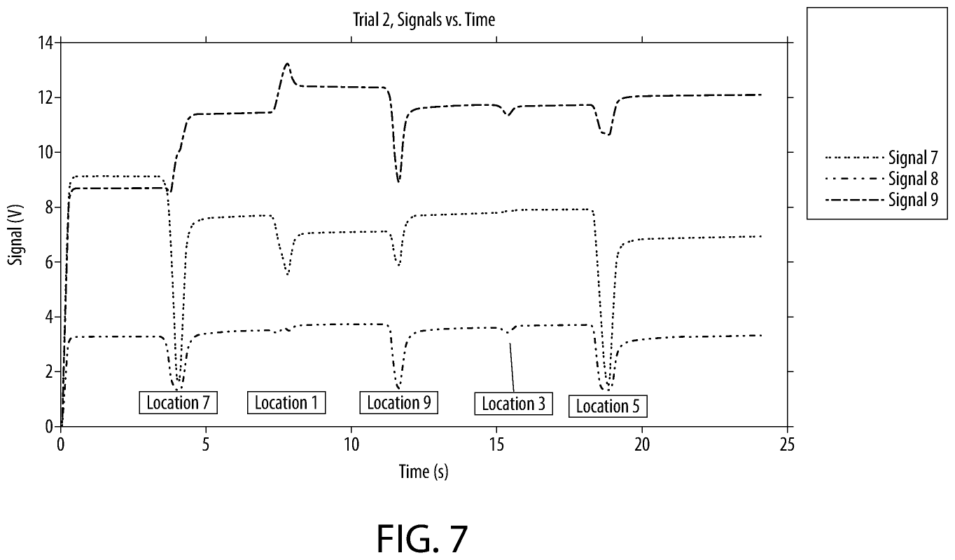

The signals for all nine Hall effect sensors were recorded in each trial and plotted to observe if there are distinct signals for the different trial parameters. FIGS. 6 through 15 show the plots for each trial described in Table 1. To simplify comparison of some representative signals FIGS. 7, 9, 11, 13, and 15 show only signals 7, 8, and 9 (the bottom row of sensors in FIG. 3).

The signals generated by the Hall effect sensors correspond to the location of the applied pressure as well the amplitude of the applied pressure. Although not shown, the signals from the Hall effect sensors may be conveyed (by wire or wirelessly) to a controller for using the haptic signal to control a robot, prosthetic, biomedical device and/or device connected to the Internet.

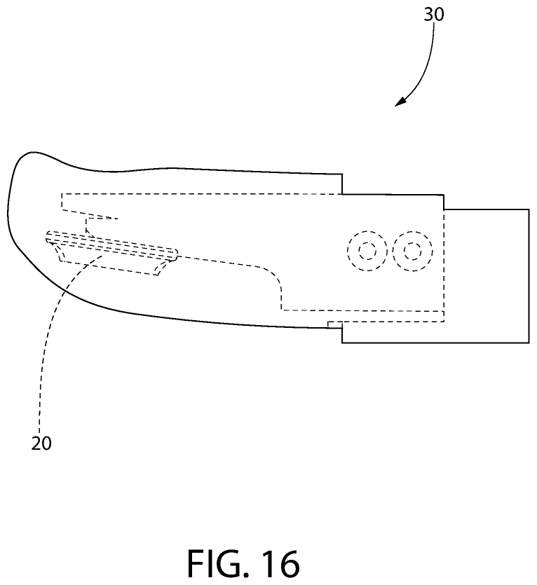

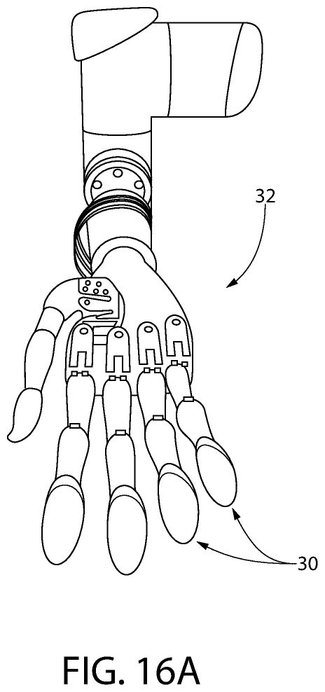

The pressure sensor 20 shows promise to distinctly detect the amplitudes and locations of applied forces with high resolution. One exemplary embodiment of the new sensor 20 is shown in FIGS. 16-16A, that could be incorporated into the fingertip 30 of a prosthetic hand 32 (e.g., an i-LIMBR), which is part of ongoing work. This fingertip tip 30 fits onto the i-LIMBR prosthetic hand when it is manufactured.

### Situational Sensor

It is also within the broadest scope of the present invention 20 to utilize the novel sensor 20 to detect acceleration and orientation with respect to gravity, hereinafter referred to as a “situational” sensor. For example, if the situational sensor 20 were rotated about any axis or if it experienced acceleration, changes in the FMF 24 distribution would occur within the deformable material 22, thereby altering the magnetic field, which would be indicative of the orientation of the sensor 20 with respect to gravity or acceleration experienced by the sensor 20. Thus, the situational sensor 20 can operate as an orientation sensor or accelerometer.

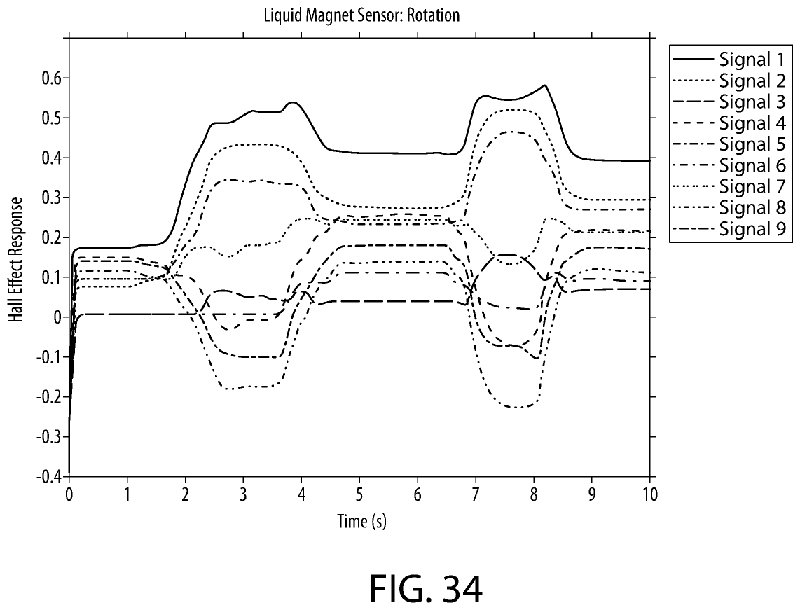

In particular, FIG. 34 depicts the Hall effect sensors' response over time when the situational sensor 20 was rotated 90 degrees and the returned to its original position twice, by way of example only. As a result, the sensor 20 is capable of detecting sensor 20 orientation as well as change in orientation.

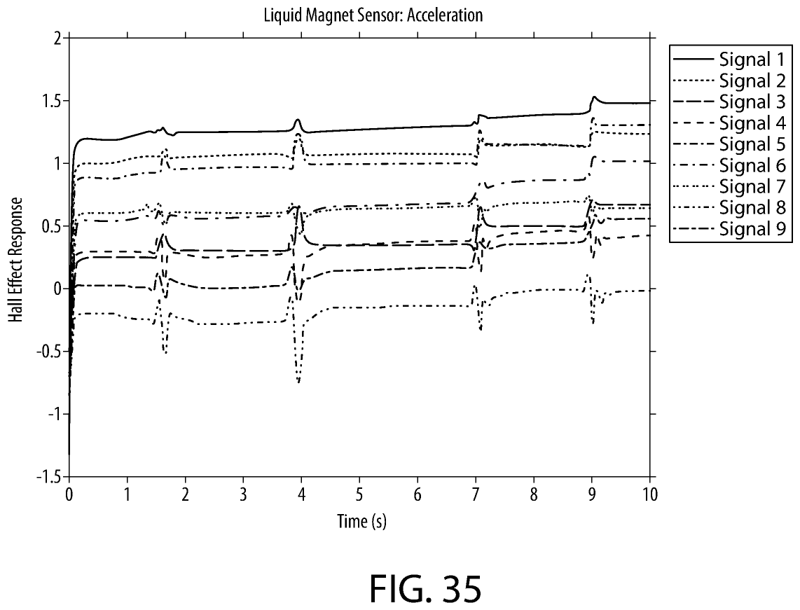

Moreover, FIG. 35 depicts the Hall effect sensors' response over time when the situational sensor was accelerated four times, by way of example only. As a result, the sensor 20 is capable of detecting sensor acceleration, including rotational acceleration as well as linear acceleration

### Torque Detection Using a Soft Magnetic Sensor Array

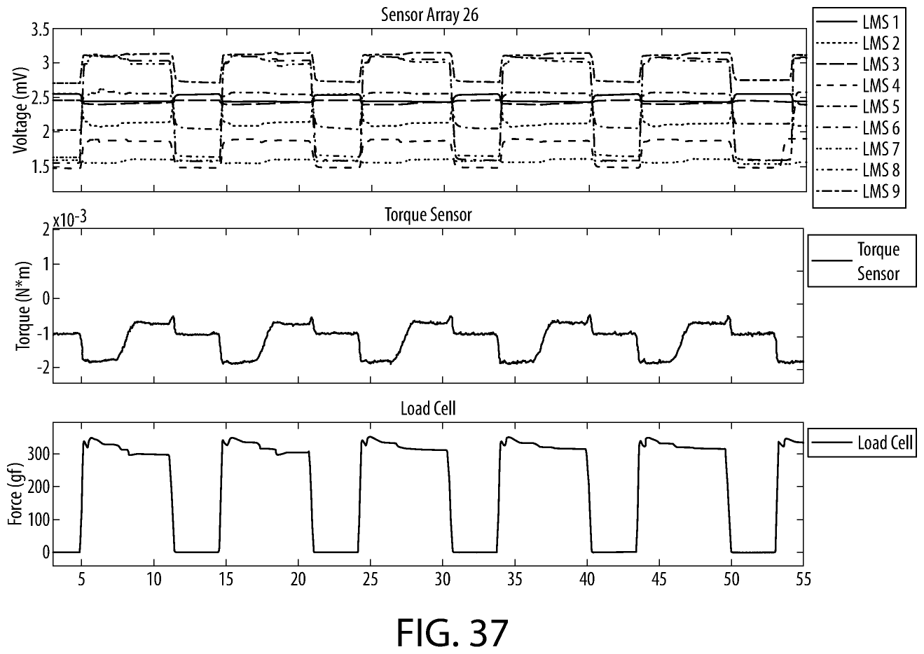

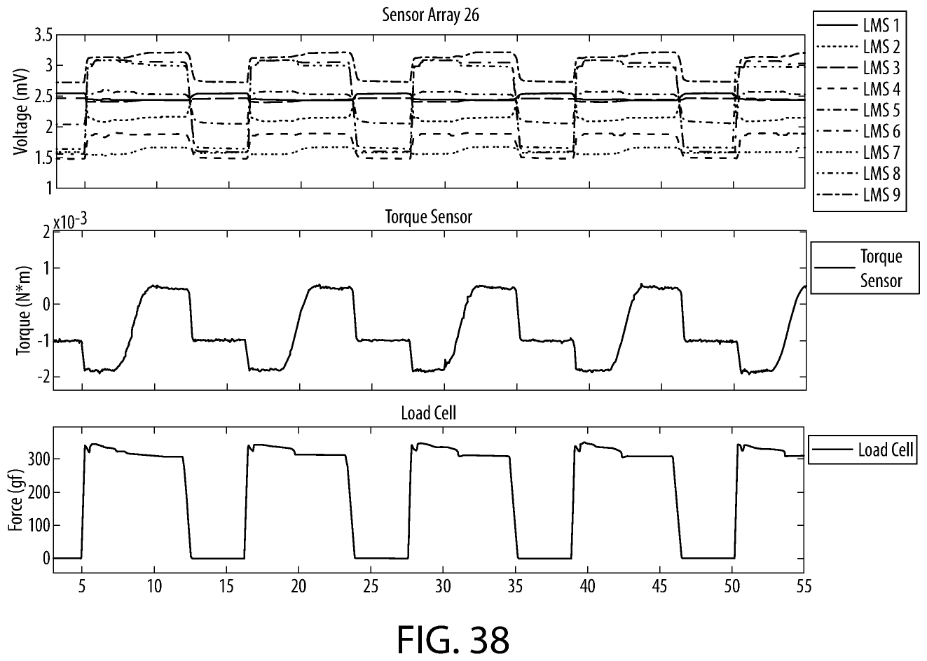

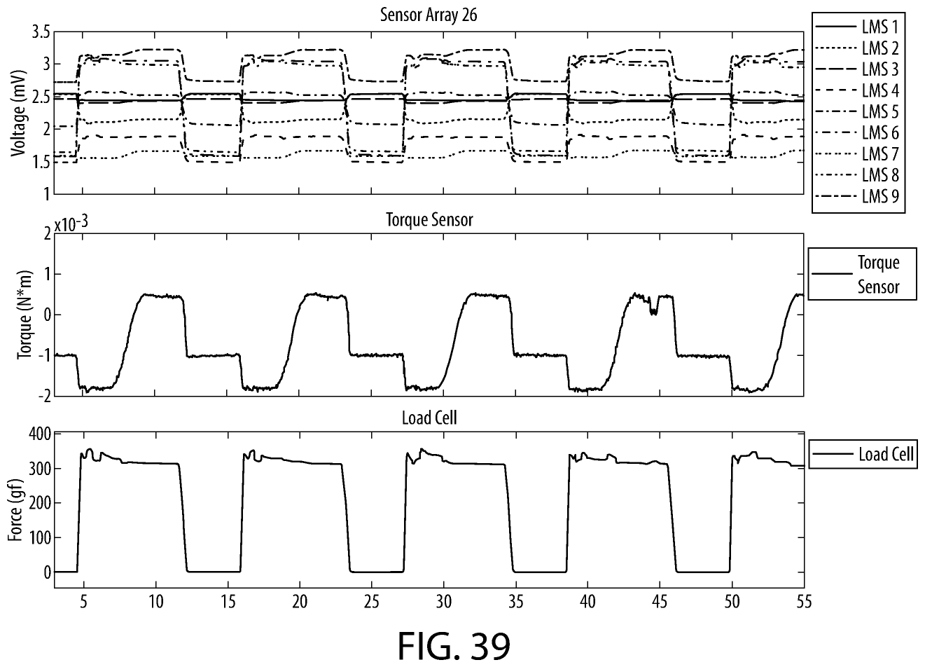

Another application of the sensor 20 is for the detection of torsion forces, namely, pressing down on the sensor 20 and then twisting or rotating the sensor 20. FIGS. 36A-36B show a configuration for applying various torque forces to the sensor 20. The sensor 20 is positioned on a load cell which in turn is positioned on an anchor to a test table (not shown). In particular, a torque application rig (TAR) applies a downward force (FIG. 36A) to the sensor 20 and then a clockwise twisting force (FIG. 36B) is applied to the sensor 20. FIGS. 37, 38 and 39 depict the respective sensor 20 outputs for 5°, 10° and 15° of clockwise rotation, as provided by the plots labeled “LMS”; an independent torque sensor was provided (not shown) to verify the torque applied to the LMS signals. By detecting these forces, the sensor 20 may be combined with other biomimetic technologies to imitate the sensing capabilities of the human nervous system. More specifically, implementation into prosthetic hands using the data collected by the sensor and haptic technology to provide user feedback, has the possibility of mimicking the human touch response. It should be further noted that the principle of twisting the sensor 20 applies a shear upon the sensor 20 surface. As such, this sensor 20 could be readily extended to detect the application of linear shear forces as well.

As mentioned earlier, a key focus in the field of bio-robotics and biomimetics is prosthetic hands. Currently, commercially available robotic prosthetic hands allow the user to receive minimal or no direct feedback from their interaction with their surroundings. To mimic the human touch response, data generated by the interaction of the prosthetic hand with objects needs to be transformed into a signal which can be easily understood by the user [11]. The types of sensors used to gather this data are divided into two categories: flexible tactile sensors and non-flexible tactile sensors. Flexible tactile sensors are better for prosthetic applications since they increase stretchability and flexibility, which combat the rigidity commonly encountered by prosthetics users [12]. These are also subject to more forces than traditional nonflexible sensors including direct probing, shear, and torsion forces, each having a different effect on the sensor [13]. The sensor used in this project contains an array of Hall effect sensors that detect the presence of a magnetic field from a custom-fabricated soft magnet. Currently, there are very few studies regarding the use of Hall effect sensors in flexible tactile sensors, which are more commonly used in nonflexible sensing technologies [14]. In addition, there is relatively no research regarding the effect and detection of shear and torque forces using a flexible tactile Hall effect sensor.

Individual signals from each of the nine Hall effect sensors were collected. As a means of external verification, normal force and torque data was collected using a load cell and torque sensor, respectively.

The sensor array 26 showed responses related to the degree of torque applied and agreed with external verification. As the magnitude of applied torsion increased, the sensor array signals increased as well.

It can be determined that the sensor array 26 shows appropriate responses to various degrees of torque two ways. First, changes in sensor signal are related to the applied degree of twist. Second, sensor array signals correspond directly to external verification signals (load cell and torque sensor).

### Sensor 20 Application in Spinal Model for Detecting the Location and Amplitude of Applied Loads

The novel sensor 20 was also positioned in a robotically actuated human spine model for monitoring intervertebral loads therein [15]. The sensor 20 was able to detect the location (using 3.25 mm spacing) and amplitude of externally applied loads (e.g., ≥10 g from a robotic arm) through five spine postures: flexion, mid-flexion, flexion, mid-extension and extension. As such, the novel sensor 20 will, among other things, allow surgeons to potentially determine post-operative effects of an artificial disc implant on a patient-specific basis prior to surgery.

### REFERENCES

[1] Hyung-Kew Lee; Sun-Il Chang; Yoon, E. (2006). A Flexible Polymer Tactile Sensor: Fabrication and Modular Expandability for Large Area Deployment., 15(6), 1681-1686. doi:10.1109/jmems.2006.886021
[2] Moss A. Robert (1994); Differential pressure transducer utilizing a variable ferrofluid keeper as an active magnetic circuit element. U.S. Pat. No. 5,396,802 (Moss)
[3] Keyson, D. V., Maher, M. L., Streitz, N., Cheok, A., Augusto, J. C., Wichert, R., . . . Kröse, B. J. A. (Eds.). (2011). Hall Effect Sensing Input and Like Polarity Haptic Feedback in the Liquid Interface System. doi: 10.1007/978-3-642-25167-2
[4] Kurosu, M. (Ed.). (2013). Magnetic Field Based Near Surface Haptic and Pointing Interface. doi: 10.1007/978-3-642-39330-3
[5] Alfadhel, Ahmed; Kosel, Jürgen (2015). Magnetic Nanocomposite Cilia Tactile Sensor. Advanced Materials, 27(47), 7888-7892. doi:10.1002/adma.201504015
[6] Goka, M; Nakamoto, H; Takenawa, S (2010). [IEEE 2010 IEEE/RSJ International Conference on Intelligent Robots and Systems (IROS 2010)—Taipei (2010.10.18-2010.10.22)] 2010 IEEE/RSJ International Conference on Intelligent Robots and Systems—A magnetic type tactile sensor by GMR elements and inductors., ( ) 885-890. doi:10.1109/iros.2010.5650283
[7] Takenawa, S. (2009). [IEEE 2009 IEEE International Conference on Robotics and Automation (ICRA)—Kobe (2009.05.12-2009.05.17)] 2009 IEEE International Conference on Robotics and Automation—A magnetic type tactile sensor using a two-dimensional array of inductors., ( ) 3295-3300. doi: 10.1109/robot.2009.5152420
[8] Melzer, Michael; Makarov, Denys; Calvimontes, Alfredo; Karnaushenko, Daniil; Baunack, Stefan; Kaltofen, Rainer; Mei, Yongfeng; Schmidt, Oliver G. (2011). Stretchable Magnetoelectronics. Nano Letters, 11(6), 2522-2526. doi:10.1021/nl201108b
[9] Mohammadi, Alireza; et al (2019). Resolving Contact Location on Magnetic-based Soft Tactile Sensors with Deformable Continuous Force Transfer Medium
[10] Kuo, Chih-Hao; Smith, Shana (2020). Mechanical feedback analysis of a ferrofluid-based module with 2D dynamic traveling waves for tactile display application. Displays, 61( ) 101926. doi:10.1016/j.displa.2019.101926
[11] Harshal A. Sonar, Aaron P. Gerratt, Stéphanie P. Lacour, and Jamie Paik. “Closed Loop Haptic Feedback Control Using a Self-Sensing Soft Pneumatic Actuator Skin”. Soft Robotics 2020 7:1, 22-29.
[12] K. Kiguchi, T. Tanaka, and T. Fukuda, “Neuro-Fuzzy Control of a Robotic Exoskeleton With EMG Signals,” IEEE Trans. Fuzzy Syst., vol. 12, no. 4, pp. 481 490, August 2004, doi: 10.1109/TFUZZ.2004.832525.
[13] Y. Wang, Y. Lu, D. Mei, and L. Zhu, “Liquid Metal-Based Wearable Tactile Sensor for Both Temperature and Contact Force Sensing,” IEEE Sens. J., vol. 21, no. 2, pp. 1694-1703, 2021, doi: 10.1109/JSEN.2020.3015949.
[14] V. Nguyen, T. Lu, P. Grimshaw, and W. Robertson, “A Novel Approach for Human Intention Recognition Based on Hall Effect Sensors and Permanent Magnets,” Progress in Electromag Research M, Vol. 92, 55-65, 2020.
[15] M. Lin, M. A. Abd, A. Taing, C. Tsai, F. Vrionis and E. Engeberg, “Robotic Replica of a Human Spine Uses Soft Magnetic Sensor Array to Forecast Intervertebral Loads and Posture After Surgery”, Sensors, 22, 212, 2022 doi.org/10.3390/s22010212

While the invention has been described in detail and with reference to specific examples thereof, it will be apparent to one skilled in the art that various changes and modifications can be made therein without departing from the spirit and scope thereof.

1. A pressure sensor, said pressure sensor comprising:
a first element comprising a deformable material having a ferrous magnetic fluid therein, said ferrous magnetic fluid exhibiting a magnetic field;
a second element positioned adjacent said first element and comprising an array of Hall effect sensors; and
said Hall effect sensors detecting changes in the magnetic field when pressure is applied against said first element, said Hall effect sensors generating output signals corresponding to a location and amplitude of at least one applied pressure on said first element.

2. The pressure sensor of claim 1 further comprising a third element positioned adjacent said second element and comprising a magnet for enhancing the magnetic field of said ferrous magnetic fluid.

3. The pressure sensor of claim 2 wherein said magnet comprises a permanent magnet.

4. The pressure sensor of claim 2 wherein said magnet comprises an electromagnet.

5. The pressure sensor of claim 1 wherein said array of Hall effect sensors comprises a three by three array.

6. The pressure sensor of claim 1 wherein said first element comprises an inner chamber for containing said ferrous magnetic fluid therein.

7. The pressure sensor of claim 1 wherein said second element comprises a circuit board having said array of said Hall effect sensors thereon.

8. The pressure sensor of claim 1 wherein said first element and said second element are fixed together to prevent any relative movement therebetween.

9. A method for distinctly detecting the amplitude and location of an applied pressure with high resolution, said method comprising:
providing a first element comprising a deformable material having a ferrous magnetic fluid therein, said ferrous magnetic fluid exhibiting a magnetic field;
positioning a second element adjacent said first element and wherein said second element comprises an array of Hall effect sensors;
applying a pressure against said first element causing said Hall effect sensors to detect changes in the magnetic field; and
generating output signals, by said Hall effect sensors, corresponding to a location and amplitude of at least one applied pressure on said first element.

10. The method of claim 9 further comprising the step of positioning a third element adjacent said second element and wherein said third element comprises a magnet for enhancing the magnetic field of said ferrous magnetic fluid.

11. The method of claim 10 wherein said step of positioning said third element comprises positioning a permanent magnet underneath said second element.

12. The method of claim 10 wherein said step of positioning said third element comprises positioning an electromagnet underneath said second element.

13. The method of claim 9 wherein said step of positioning the second element comprises including a three by three array of Hall effect sensors thereon.

14. The method of claim 9 wherein said step of providing the first element comprises providing an inner chamber within said deformable material for containing said ferrous magnetic fluid therein.

15. The method of claim 9 wherein said step of positioning the second element comprises having said array of Hall effect sensors electrically coupled on a printed circuit board.

16. The method of claim 9 wherein said step of positioning the second element adjacent said first element comprises positioning said second element underneath said first element.

17. The method of claim 16 wherein said step of positioning said second element underneath said first element comprises fixing said first and second elements together to prevent any relative movement therebetween.

18. The method of claim 9 wherein said first element and said second element form a sensor and wherein said step of applying pressure against said first element comprises applying a torsion force comprising a downward and twisting force upon said first element causing changes in the magnetic field of the ferrous magnetic fluid and wherein said output signals are indicative of said torsion force applied to said sensor.

19. The method of claim 9 wherein said first element and said second element form a sensor and wherein said step of applying pressure against said first element comprises applying linear shear forces upon a surface of said first element, said applied linear shear forces causing changes in the magnetic field of the ferrous magnetic fluid and wherein said output signals are indicative of said linear shear forces applied to said sensor.

20. A situational sensor for detecting orientation or acceleration, said sensor comprising:
a first element comprising a ferrous magnetic fluid therein, said ferrous magnetic fluid exhibiting a magnetic field;
a second element positioned underneath said first element and comprising an array of Hall effect sensors; and
said Hall effect sensors detecting changes in the magnetic field as said ferrous magnetic fluid redistributes within said first element, corresponding to situational sensor orientation or acceleration, and generating output signals corresponding to said situational sensor orientation or situational sensor acceleration.

21. (canceled)

22. (canceled)
